(19) United States
(12) Patent Application Publication
(10) Pub. No.: US 2025/0081042 A1
(43) Pub. Date: Mar. 6, 2025

(54) AI-ASSISTED ADJUSTMENT OF A 5G NETWORK

(71) Applicant: DISH Wireless L.L.C., Littleton, CO (US)

(72) Inventor: Arpit Agarwal, Highlands Ranch, CO (US)

(21) Appl. No.: 18/460,220

(22) Filed: Sep. 1, 2023

(51) Int. Cl. H04W 28/08; H04W 28/10

(52) U.S. Cl. CPC H04W 28/0942; H04W 28/10

(57) ABSTRACT

A method may include accessing event data corresponding to an event affecting a region covered by a 5G network including a plurality of network components. The method may include accessing user data corresponding to a user equipment within the region covered by the 5G network. The method may include generating, using a machine learning model, an expected network load. The method may include accessing, a dynamic threshold associated with the 5G network. The dynamic threshold may include one or more limits associated with the plurality of network components. The method may include determining that the expected network load will cause the 5G network to exceed at least one limit of the dynamic threshold. In response to determining that the expected network load will exceed the limit, the method may include generating a new network component in the 5G network based at least in part on the expected network load.

### BACKGROUND

A network capacity of a wireless network may be limited by properties of one or more components of the wireless network. If the network capacity is exceeded, some of the components may fail, causing the wireless network to have performance issues. Furthermore, events within the coverage area may be unpredictable, leading to spikes in network traffic that may exceed the network capacity.

### BRIEF SUMMARY

A method may include accessing, by a computing device, event data from a data source, the event data corresponding to an event affecting a region covered by a 5G network including a plurality of network components. The method may include accessing, by the computing device, user data corresponding to a user equipment within the region covered by the 5G network. The method may include generating, by the computing device and using a machine learning model, an expected network load, where the machine learning model uses at least one of the event data and the user data to generate the expected network load. The method may include accessing, by a computing device, a dynamic threshold associated with the 5G network, the dynamic threshold may include one or more limits associated with the plurality of network components. The method may include determining, by the computing device, that the expected network load will cause the 5G network to exceed at least one limit of the one or more limits of the dynamic threshold. In response to determining that the expected network load will exceed the at least one limit of the one or more limits the method may include generating, by the computing device, a new network component in the 5G network based at least in part on the expected network load.

In some embodiments, the method may include determining, by the computing device, that a network load is below the at least one limit of the one or more limits of the dynamic threshold. The method may include causing, by the computing device, the new network component to be removed from the 5G network. The new network component may be configured to add a minimum amount of a network capacity to the 5G network covering the region such that the network capacity meets or exceeds the expected network load. The one or more limits may be based at least in part on a data mix, the data mix may include variable amounts of a plurality of data types. The user data may include historical data usage information associated with the user equipment. The historical data usage information may include at least one of a voice data usage, an application data usage, a short-message service data usage, location information, and time information associated with the historical data information. The user data may include at least one of an events database, a news source, an emergency communications network, and traffic data. The 5G network may be implemented in a distributed cloud-based architecture. The 5G network may include a standalone 5G network. The dynamic threshold may be generated at least in part by injecting synthetic data into a test 5G network.

A system may include one or more processors, a monitor array, a machine learning model, a network controller, and a non-transitory computer-readable medium including instructions that, when executed by the one or more processors, cause the system to perform operations. According to the operations, the monitor array may access event data from a data source, the event data corresponding to an event affecting a region covered by a 5G network including a plurality of network components. The monitor array may access user data corresponding to a user equipment within the region covered by the 5G network. The machine learning model may generate an expected network load, where the machine learning model uses at least one of the event data and the user data to generate the expected network load. The network controller may access a dynamic threshold associated with the 5G network. The dynamic threshold may include one or more limits associated with the plurality of network components. The network controller determine that the expected network load will cause the 5G network to exceed at least one limit of the one or more limits of the dynamic threshold. In response to determining that the expected network load will exceed the at least one limit of the one or more limit, the network controller may generate a new network component in the 5G network based at least in part on the expected network load.

In some embodiments the network monitor may collect data associated with a current state of the 5G network and/or one or more performance metrics of the 5G network. The network controller may utilize the collected data associated with the current state of the 5G network and/or the one or more performance metrics to determine that the expected network load will cause the 5G network to exceed at least one limit of the one or more limits of the dynamic threshold. The machine learning model may include one or more of an artificial neural network, a Bayesian network, a ridge regression model, and a k-nearest neighbors model. The user data may include at least one of an events database, a news source, an emergency communications network, and traffic data. The 5G network may be implemented in a distributed cloud-based architecture. The 5G network may include a standalone 5G network. The dynamic threshold may be generated at least in part by injecting synthetic data into a test 5G network.

A non-transitory computer-readable medium may include instructions that, when executed by a processor, cause the processor to perform operations including accessing, by a computing device, event data from a data source, the event data corresponding to an event affecting a region covered by a 5G network including a plurality of network components. The operations may include accessing, by the computing device, user data corresponding to a user equipment within the region covered by the 5G network. The operations may include generating, by the computing device and using a machine learning model, an expected network load, where the machine learning model uses at least one of the event data and the user data to generate the expected network load. The operations may include accessing, by a computing device, a dynamic threshold associated with the 5G network, the dynamic threshold may include one or more limits associated with the plurality of network components. The operations may include determining, by the computing device, that the expected network load will cause the 5G network to exceed at least one limit of the one or more limits of the dynamic threshold. In response to determining that the expected network load will exceed the at least one limit of the one or more limits the operations may include generating, by the computing device, a new network component in the 5G network based at least in part on the expected network load.

In some embodiments, the operations may include determining, by the computing device, that a network load is below the at least one limit of the one or more limits of the dynamic threshold and causing, by the computing device, the new network component to be removed from the 5G network. The new network component may be configured to add a minimum amount of a network capacity to the 5G network covering the region such that the network capacity meets or exceeds the expected network load.

### BRIEF DESCRIPTION OF THE DRAWINGS

FIG. 1A illustrates an embodiment of a cellular network system, according to certain embodiments.

FIG. 1B illustrates an exemplary core, according to certain embodiments.

FIG. 2 illustrates an embodiment of a cellular network core network topology as implemented on a public cloud-computing platform, according to certain embodiments.

FIG. 3 illustrates a system and a process for a machine learning adjustment of a 5G network, according to certain embodiments.

FIG. 4 illustrates a simplified diagram of a system for adjusting a 5G network, according to certain embodiments.

FIG. 5A illustrates a 5G network with an event in a coverage area, according to certain embodiments.

FIG. 5B illustrates the computing device adjusting the 5G network in response to the event 520, according to certain embodiments.

FIG. 5C illustrates the computing device adjusting the 5G network due to the termination of an event, according to certain embodiments.

FIG. 6 illustrates a flowchart of a method for adjusting a 5G network, according to certain embodiments.

### DETAILED DESCRIPTION

A 5G wireless network may include several network components working in conjunction with one another in order to provide wireless service across a region. Some or all of the network components may be implemented via a cloud-based architecture, hosted by a public cloud-services provider (e.g., Amazon Web Services®, Microsoft Azure®, etc.). One advantage to a cloud-based architecture like the one described above may be an ability to generate more components in order to meet an expected service need. For example, a wireless network may include both hardware and software components. If network traffic exceeds a capacity of a hardware component, adding additional hardware components may increase the capacity of the wireless network. Adding more hardware components may be both slow and expensive, and thus may generally be able to handle significantly more network traffic than expected.

By contrast, software-based network components may have a capacity significantly lower than the capacity of hardware-based components. The software components (sometimes “network components”), however, may be quickly replicated, with multiple instances of the same network component performing similar tasks within the wireless network. In wireless networks where the software components are hosted by the 5G wireless network provider, a limiting factor may be the amount of storage and/or processing power the 5G wireless network provider owns. In a cloud-based architecture, however, the amount of storage and processing power available may far exceed that of the 5G wireless network provider, allowing more software components to be created essentially at will.

In order to create more network components, a 5G wireless network provider may need to know which network components will fail at what point. For example, during a period of unusually high voice volume on a wireless network, an Internet Protocol Multimedia Service (IMS) may fail. During a period of unusually high application data volume on the wireless network, a user plane function (UPF may fail). Other data types may cause other failures. However, typical wireless network traffic may generally include a high volume of solely a particular data type (e.g., voice data, application data, multimedia messaging service data, etc.), but rather a data mix composed of various data types at various respective levels. The data mix of wireless network traffic may vary constantly, with the amounts of each data type changing independently at all times. Specific data mixes at any given point may cause yet other failures, sometimes unpredictably.

Furthermore, the volumes of wireless network traffic may be inconsistent. In a given region, wireless network traffic may generally include a data mix that is relatively consistent, with the amounts and types of data in the data mix relatively stable. An event within the given region, however, may cause the wireless network traffic to increase and/or substantially change the data mix. For example, a traffic collision, natural disaster or some other unforeseen event may cause the wireless network traffic to spike, overwhelming some or all of the network components the 5G network. In other examples, a parade, a concert, or other event may also cause the wireless network traffic to overwhelm some or all of the network components of the 5G network.

Due in part to the flexibility of a cloud-based architecture, the 5G wireless network provider may be able to adjust a 5G network in order to compensate for a spike in wireless network traffic. For example, if the 5G wireless network provider knew ahead of time that a certain event would likely result in a spike in wireless network traffic, the 5G wireless network provider may be able to generate additional instances of the network components likely to fail. One solution may be to overbuild the 5G network, with more network components than needed or expected. Another solution may be to increase the total number of network components of the 5G network in response to the event. Both of these solutions, however, may be resource intensive, costing computing power and money for unneeded network components. For example, only a subset of the network components may require additional instances to compensate for the spike in wireless network traffic.

In the solutions above, additional instances of all network components may be generated, even when not needed. A more precise approach may therefore be more efficient, where instances of certain network components are generated based on need, before the 5G network is overwhelmed. However, to do so, the 5G wireless network provider may need to know the thresholds of the network components of the 5G network and an expected network load (including a data mix and total data volume) associated with the event.

In an embodiment, a machine learning model (MLM) may be trained to generate an expected network load based on an event occurring within a region covered by a 5G network. The MLM may be trained on past events and historical network data corresponding to the past events. In other words, the MLM may be able to predict the expected network load associated with an event based at least in part on an event-type. For example, a first type of event (e.g., a traffic jam) may be associated with a spike in voice data, and a second type of event (e.g., a concert) may be associated with a spike in application data. Both events may be associated with an overall increase in the network traffic handled by the 5G network.

A computing device include a dynamic threshold. The dynamic threshold may include data indicating one or more data mixes that are likely to cause at least one network component of the 5G network to fail. A spike in voice data, for example, may cause a component of an Internet Protocol Multimedia Subsystem (IMS) to fail, whereas a spike in application data may cause a user plane function (UPF) to fail. The computing device may also monitor one or more performance metrics of the 5G network and compare the one or more performance metrics to the dynamic threshold to determine whether existing network components of the 5G network are capable of handling the current network traffic on the 5G network.

The computing device may also monitor one or more data sources to determine events occurring in the region services by the 5G network. The data sources may include a news feed, a really simple syndication (RSS) feed, an emergency service feed (e.g., police radio bands), digital event calendars, and other such data sources. The computing device may also access communications metadata associated with user equipment (UE) within the region serviced by the 5G network. The communications metadata may include specific historical user data about each UE such as data usage vs time, average data mixes, location data, and other data that may indicate the UE's likely data usage.

An event may occur within the region serviced by the 5G network. The computing device may determine the event occurred based on data accessed from a data source. The computing device may then access the communications metadata associated with some or all of the UEs within the region. The computing device may then provide the data accessed from the data source and the user data to the MLM. The MLM may then output an expected network load including an expected data mix and an expected network traffic load, an expected duration of the expected network load, and other predictive network data. The computing device may then compare the expected network load to the one or more performance metrics of the 5G network and the dynamic threshold to determine if the capacity of the existing network components can accommodate the expected network load.

Upon determining that the expected network load may exceed the capacity of the existing network components, the computing device may cause new instances of some or all of the network components to be generated and deployed within the 5G network. The new instances may also be configured to provide just enough more capacity to accommodate the expected network load. For example, the event may be associated with a spike in application data. Using the MLM, the one or more performance metrics, and the dynamic threshold, the computing device may determine that the UPF only needs an increase of 10% capacity of functions provided by the UPF to accommodate the expected network load. The computing device may then cause a new UPF to be generated and deployed within the 5G network such that only a 10% increase in UPF-functionality is added to the 5G network. In some embodiments, room for error may be provided (e.g., adding a 12% increase in UPF functionality).

Using the processes and systems outlined above, a 5G wireless network provider may predict network traffic loads and data mixes before an event happens. Also, by monitoring the performance of the 5G network, the computing device may determine that the predicted network traffic load may cause one or more failures of network components of the 5G network. The computing device may therefore cause network components to be generated and deployed within the 5G network, providing robustness to the 5G network. Furthermore, because certain network components may be added according to need (as opposed to increasing a capacity of all network components), the increasing the capacity of the 5G network may be done more efficiently, saving time, and computing power.

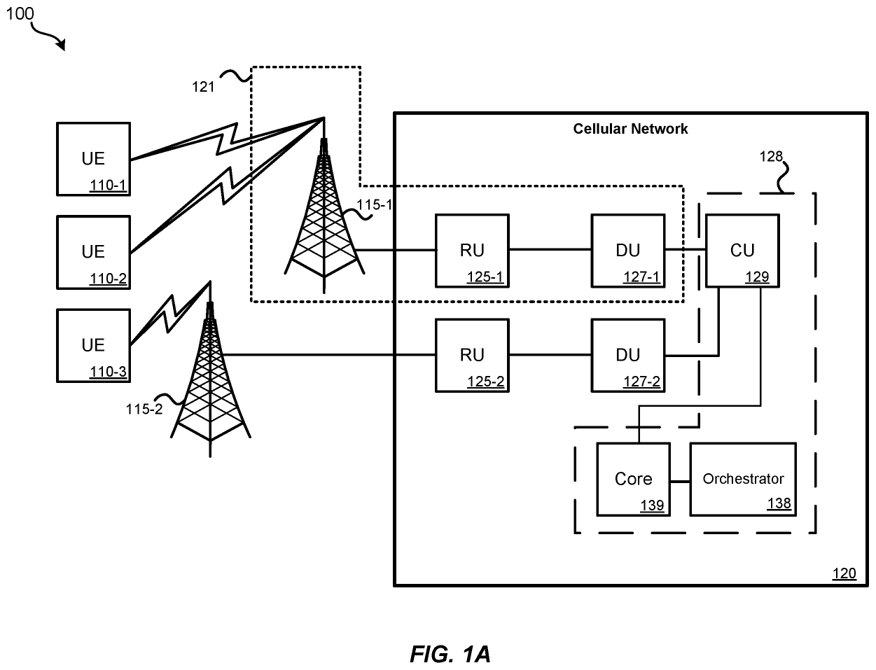

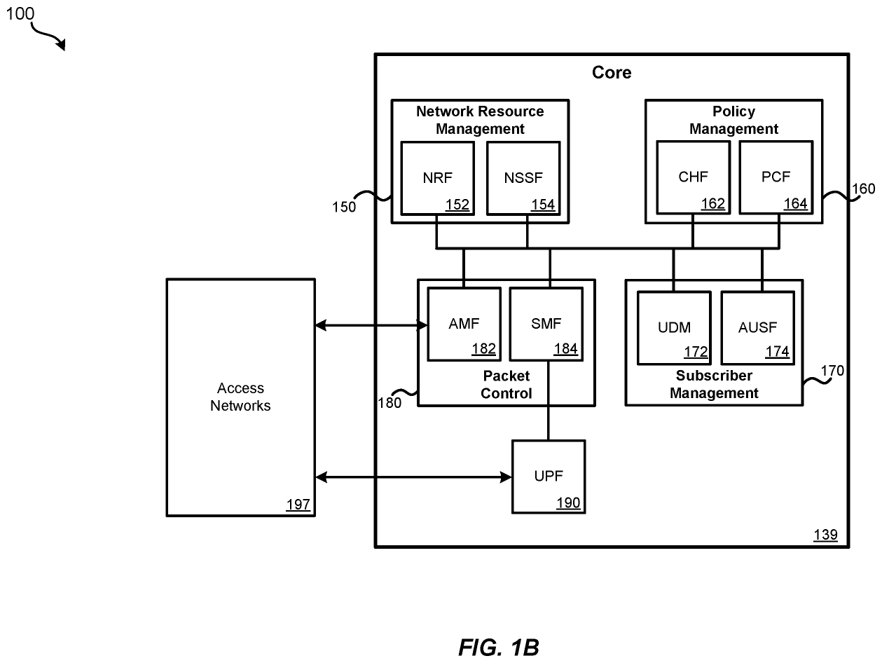

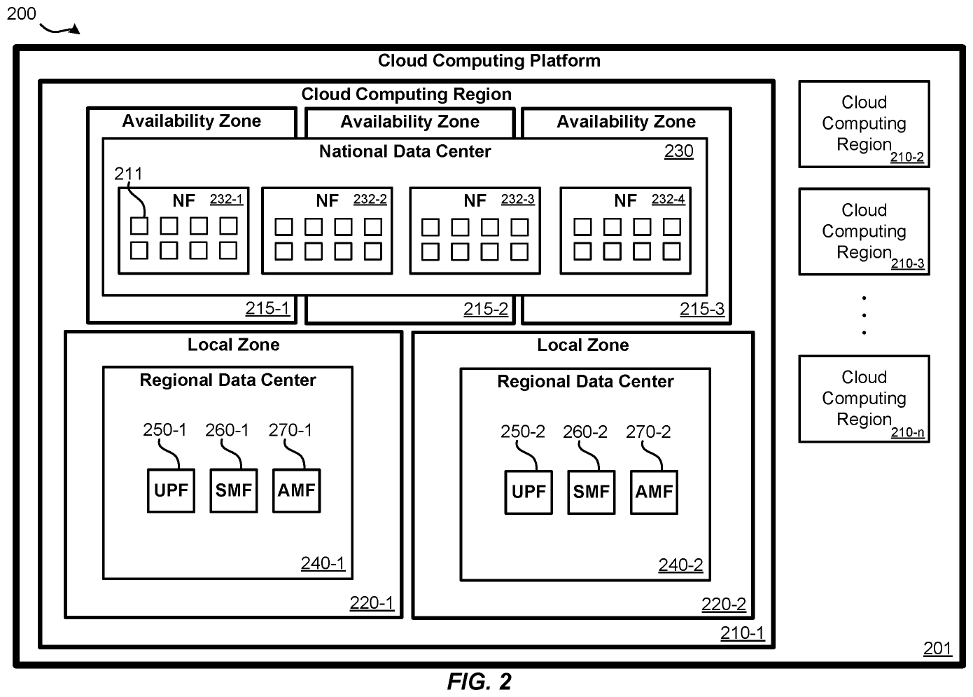

FIG. 1A illustrates an embodiment of a cellular network system 100 (“system 100”), according to certain embodiments. System 100 can include a 5G New Radio (NR) cellular network; other types of cellular networks, such as 4G LTE, 6G, 7G, etc. are also possible. System 100 can include: UE 110 (UE 110-1, UE 110-2, UE 110-3); base station 115; cellular network 120; radio units 125 (“RUs 125”); distributed units 127 (“DUs 127”); centralized unit 129 (“CU 129”); core 139, and orchestrator 138. FIG. 1A represents a component level view. In a virtualized open radio access network (O-RAN), because components can be implemented as software in the cloud, except for components that need to receive and transmit RF, the functionality of various components can be shifted among different servers, for which the hardware may be maintained by a separate (public) cloud-service provider, to accommodate where the functionality of such components is needed, as detailed in relation to FIG. 2.

UE 110 can represent various types of end-user devices, such as smartphones, cellular modems, cellular-enabled computerized devices, sensor devices, manufacturing equipment, gaming devices, access points (APs), any computerized device capable of communicating via a cellular network, etc. UE can also represent any type of device that has incorporated a 5G interface, such as a 5G modem. Examples include sensor devices, Internet of Things (IoT) devices, manufacturing robots; unmanned aerial (or land-based) vehicles, network-connected vehicles, environmental sensors, etc. UE 110 may use RF to communicate with various base stations of cellular network 120. As illustrated, two base stations 115 (BS 115-1, 115-2) are illustrated. Real-world implementations of system 100 can include many (e.g., hundreds, thousands) of base stations, and many RUs, DUs, and CUs. BS 115 can include one or more antennas that allow RUs 125 to communicate wirelessly with UEs 110. RUs 125 can represent an edge of cellular network 120 where data is transitioned to wireless communication. The radio access technology (RAT) used by RU 125 may be 5G New Radio (NR), or some other RAT, such as 4G Long Term Evolution (LTE). The remainder of cellular network 120 may be based on an exclusive 5G architecture, a hybrid 4G/5G architecture, a 4G architecture, or some other cellular network architecture. Base station equipment 121 may include an RU (e.g., RU 125-1) and a DU (e.g., DU 127-1) located on site at the base station. In some embodiments, the DU may be physically remote from the RU. For instance, multiple DUs may be housed at a central location and connected to geographically distant (e.g., within a couple kilometers) RUs.

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. One or more DUs, such as DU 127-1, may communicate with CU 129. Collectively, RUs, DUs, and CUs create a gNodeB, which serves as the radio access network (RAN) of cellular network 120. CU 129 can communicate with core 139. The specific architecture of cellular network 120 can vary by embodiment. Edge cloud server systems outside of cellular network 120 may communicate, either directly, via the Internet, or via some other network, with components of cellular network 120. For example, DU 127-1 may be able to communicate with an edge cloud server system without routing data through CU 129 or core 139. Other DUs may or may not have this capability.

At a high level, the various components of a gNodeB can be understood as follows: RUs perform RF-based communication with UE. DUs support lower layers of the protocol stack such as the radio link control (RLC) layer, the medium access control (MAC) layer, and the physical communication layer. CUs support higher layers of the protocol stack such as the service data adaptation protocol (SDAP) layer, the packet data convergence protocol (PDCP) layer and the radio resource control (RRC) layer. A single CU can provide service to multiple co-located or geographically distributed DUs. A single DU can communicate with multiple RUs.

Further detail regarding exemplary core 139 is provided in relation to FIG. 1B. FIG. 1B illustrates an exemplary core 139, according to certain embodiments. The exemplary core 139 can be physically distributed across data centers or located at a central national data center (NDC) as detailed in relation to FIG. 2, can perform various core functions of the cellular network. Core 139 can include: network resource management components 150; policy management components 160; subscriber management components 170; and packet control components 180. Individual components may communicate on a bus, thus allowing various components of core 139 to communicate with each other directly. Core 139 is simplified to show some key components. Implementations can involve additional other components.

Network resource management components 150 can include: Network Repository Function (NRF) 152 and Network Slice Selection Function (NSSF) 154. NRF 152 can allow 5G network functions (NFs) to register and discover each other via a standards-based application programming interface (API). NSSF 154 can be used by AMF 182 to assist with the selection of a network slice that will serve a particular UE.

Policy management components 160 can include: Charging Function (CHF) 162 and Policy Control Function (PCF) 164. CHF 162 allows charging services to be offered to authorized network functions. Converged online and offline charging can be supported. PCF 164 allows for policy control functions and the related 5G signaling interfaces to be supported.

Subscriber management components 170 can include: Unified Data Management (UDM) 172 and Authentication Server Function (AUSF) 174. UDM 172 can allow for generation of authentication vectors, user identification handling, NF registration management, and retrieval of UE individual subscription data for slice selection. AUSF 174 performs authentication with UE.

Packet control components 180 can include: Access and Mobility Management Function (AMF) 182 and Session Management Function (SMF) 184. AMF 182 can receive connection- and session-related information from UE and is responsible for handling connection and mobility management tasks. SMF 184 is responsible for interacting with the decoupled data plane, creating updating and removing Protocol Data Unit (PDU) sessions, and managing session context with the User Plane Function (UPF).

User plane function (UPF) 190 can be responsible for packet routing and forwarding, packet inspection, QoS handling, and external PDU sessions for interconnecting with a Data Network (DN) (e.g., the Internet) or various access networks 197. Access networks 197 can include the RAN of cellular network 120 of FIG. 1A.

While FIGS. 1A and 1B illustrate various components of cellular network 120, it should be understood that other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In a virtualized arrangement, specialized software on general-purpose hardware may be used to perform the functions of components such as DU 127, CU 129, and core 139. Functionality of such components can be co-located or located at disparate physical server systems. For example, certain components of core 139 may be co-located with components of CU 129.

In a possible O-RAN implementation, DUs 127, CU 129, core 139, and/or orchestrator 138 can be implemented virtually as software being executed by general-purpose computing equipment, such as in a data center. Therefore, depending on needs, the functionality of a DU, CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100, cloud-based cellular network components 128 include CU 129, core 139, and orchestrator 138. In some embodiments, DUs 127 may be partially or fully added to cloud-based cellular network components 128. Such cloud-based cellular network components 128 may be executed as specialized software executed by underlying general-purpose computer servers. Cloud-based cellular network components 128 may be executed on a public third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested. A “public” cloud-based computing platform refers to a platform where various unrelated entities can each establish an account and separately utilize the cloud computing resources, the cloud computing platform managing segregation and privacy of each entity's data.

Kubernetes, or some other container orchestration platform, can be used to create and destroy the logical DU, CU, or 5G core units and subunits as needed for the cellular network 120 to function properly. Kubernetes allows for container deployment, scaling, and management. As an example, if cellular traffic increases substantially in a region, an additional logical DU or components of a DU may be deployed in a data center near where the traffic is occurring without any new hardware being deployed. (Rather, processing and storage capabilities of the data center would be devoted to the needed functions.) When the need for the logical DU or subcomponents of the DU no longer exists, Kubernetes can allow for removal of the logical DU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new DU, orchestrator 138 can perform a pipeline of calling the DU code from a software repository incorporated as part of, or separate from, cellular network 120; pulling corresponding configuration files (e.g., helm charts); creating Kubernetes nodes/pods; loading DU containers; configuring the DU; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet particular SLA levels and parameters. By controlling the location and amount of computing and communication resources allocated to a network slice, the SLA attributes for UE on the network slice can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1, a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

As illustrated in FIG. 1A, UE 110 may be operating on one or more production slices of cellular network 120. As detailed later in this document, UE that function on a particular entity's local network may be assigned to a slice particular to the entity or a slice that provides a particular QoE for tasks to be performed by the entity's UE.

Components such as DUs 127, CU 129, orchestrator 138, and core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

FIG. 2 illustrates an embodiment of a cellular network core network topology 200 as implemented on a public cloud-computing platform, according to certain embodiments. Cellular network core network topology 200 can represent how logical cellular network groups are distributed across cloud computing infrastructure of cloud computing platform 201. Cloud computing platform 201 can be logically and physically divided up into various different cloud computing regions 210. Each of cloud computing regions 210 can be isolated from other cloud computing regions to help provide fault tolerance, fail-over, load-balancing, and/or stability and each of cloud computing regions 210 can be composed of multiple availability zones, each of which can be a separate data center located in general proximity to each other (e.g., within 600 miles). Further, each of cloud computing regions 210 may provide superior service to a particular geographic region based on physical proximity. For example, cloud computing region 210-1 may have its datacenters and hardware located in the northeast of the United States while cloud computing region 210-2 may have its datacenters and hardware located in California. For simplicity, the details of the cellular network as executed in only cloud computing region 210-1 is illustrated. Similar components may be executed in other cloud computing regions of cloud computing regions 210 (210-2, 210-3, 210-n).

In other embodiments, cloud computing platform 201 may be a private cloud computing platform. A private cloud computing platform may be maintained by a single entity, such as the entity that operates the hybrid cellular network. Such a private cloud computing platform may be only used for the hybrid cellular network and/or for other uses by the entity that operates the hybrid cellular network (e.g., streaming content delivery).

Each of cloud computing regions 210 may include multiple availability zones 215. Each of availability zones 215 may be a discrete data center or group of data centers that allows for redundancy that allows for fail-over protection from other availability zones within the same cloud computing region. For example, if a particular data center of an availability zone experiences an outage, another data center of the availability zone or separate availability zone within the same cloud computing region can continue functioning and providing service. A logical cellular network component, such as a national data center, can be created in one or across multiple availability zones 215. For example, a database that is maintained as part of NDC 230 may be replicated across availability zones 215; therefore, if an availability zone of the cloud computing region is unavailable, a copy of the database remains up-to-date and available, thus allowing for continuous or near continuous functionality.

On a (public) cloud computing platform, cloud computing region 210-1 may include the ability to use a different type of data center or group of data centers, which can be referred to as local zones 220. For instance, a client, such as a provider of the hybrid cloud cellular network can select from more options of the computing resources that can be reserved at an availability zone compared to a local zone. However, a local zone may provide computing resources nearby geographic locations where an availability zone is not available. Therefore, to provide low latency, certain network components, such as regional data centers, can be implemented at local zones 220 rather than availability zones 215. In some circumstances, a geographic region can have both a local zone and an availability zone.

In the topology of a 5G NR cellular network, 5G core functions of core 139 can logically reside as part of a national data center (NDC). NDC 230 can be understood as having its functionality existing in cloud computing region 210-1 across multiple availability zones 215. At NDC 230, various network functions, such as NFs 232, are executed. For illustrative purposes, each NF, whether at NDC 230 or elsewhere located, can be comprised of multiple sub-components, referred to as pods (e.g., pod 211) that are each executed as a separate process by the cloud computing environment. The illustrated number of pods is merely an example; fewer or greater numbers of pods may be part of the respective 5G core functions. It should be understood that in a real-world implementation, a cellular network core, whether for 5G or some other standard, can include many more network functions. By distributing NFs 232 across availability zones, load-balancing, redundancy, and fail-over can be achieved. In local zones 220, multiple regional data centers 240 can be logically present. Each of regional data centers 240 may execute 5G core functions for a different geographic region or group of RAN components. As an example, 5G core components that can be executed within an RDC, such as RDC 240-1, may be: UPFs 250, SMFs 260, and AMFs 270. While instances of UPFs 250 and SMFs 260 may be executed in local zones 220, SMFs 260 may be executed across multiple local zones 220 for redundancy, processing load-balancing, and fail-over.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

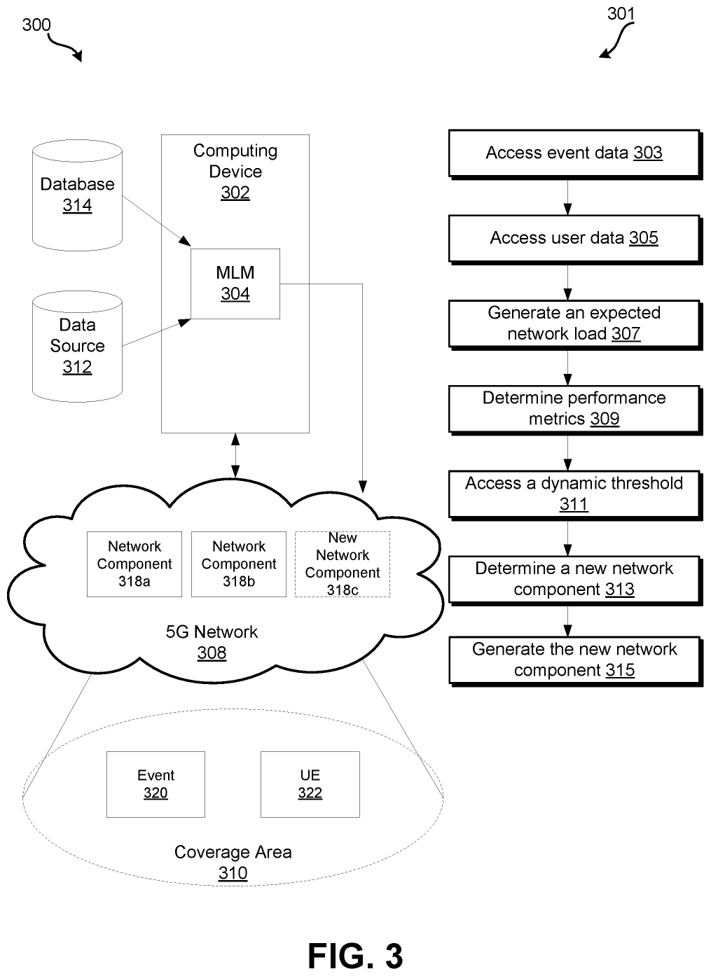

FIG. 3 illustrates a system 300 and a process 301 for a machine learning adjustment of a 5G network, according to certain embodiments. The system 300 may include a computing device 302 with a machine learning model (MLM) 304. The computing device 302 may be a single computing device or may be implemented in a distributed cloud-based architecture. The computing device 302 may be configured to monitor and communicate with a 5G network 308 (and/or components thereof). The 5G network 308 may provide wireless services to a coverage area 310. Although the 5G network 308 is shown and described as a 5G network, it should be understood that the 5G network 308 may provide any wireless network, including 4G LTE, 4G/5G hybrid networks, 6G, 7G, etc.

The 5G network 308 may include network components 318a-b. The network components 318a-b may be similar to any of the network components described in FIGS. 1A-B (e.g., a UPF, an SMF, an SBC, etc.). The network components 318a-b (and therefore the 5G network 308) may be implemented in a cloud-based architecture, hosted by a public cloud-services provider. In some embodiments, the computing device 302 may be hosted by the same public cloud services provider as the 5G network 308. Thus, the computing device 302 may be considered part of the 5G network 308.

The computing device 302 may access a data source 312 and a database 314. The data source 312 may include a news feed, an RSS feed, emergency services communications systems, events calendars, and other sources that may provide data about future and/or current events. For example, the data source 312 may be a publicly available website associated with an events venue. The data source 312 may therefore include data indicating dates and times associated with events hosted at the event venue. Additionally or alternatively, the data source 312 may include an emergency services feed, indicating an on-going emergency or alert (e.g., a weather alert pushed via the 5G network 308). In yet another example, the data source 312 may be a news source and include traffic data relevant to the coverage area 310.

The computing device 302 may also access a database 314. The 5G network provider may store communications metadata on the database 314. For example, the database 314 may include communications metadata associated with a UE 322. The database 314 may include user metadata associated with only those UEs within the coverage area 310 or may include user metadata associated with UEs that are customers of the 5G wireless network provider in any coverage area. The communications metadata may include call data records (CDRs) and other metadata that indicates a usage history of the UEs. For example, the communications metadata may include data usage vs time, average data mixes, location data, and other such data.

At step 303, the computing device 302 may access event data indicating an event 320 from the data source 312. For example, the event 320 may be a vehicular accident on a roadway within the coverage area 310 or in a nearby area. The data source 312 may then be a news source or other source of traffic information. In another example, the event 320 may be a concert within the coverage area 310. Then, the data source 312 may be an online events calendar, a website associated with a venue hosting the event 320, or other such data source.

In some embodiments, the computing device 302 may detect a change in the network traffic of the 5G network 308 (e.g., a sudden increase in total network traffic, a sudden change in data mix, etc.). In response, the computing device 302 may access the data source 312 in order to determine if the event 320 has taken place and identify the event 320. In other words, the computing device 302 may detect the event 320 before receiving an indication of the event from the data source 312, then use the data source 312 to identify the event 320.

At step 305, the computing device 302 may access user data associated with the UE 322 from the database 314. The user data may include communications metadata as described above. At step 307, the computing device 302 may generate an expected network load associated with the event 320 and/or the UE 322. The computing device 302 may provide the event data and the user data to the MLM 304. The MLM 304 may be a neural network or other model, trained using historical network data and/or historical event data. The MLM 304 may therefore determine the expected network load based on the event 320 and/or the UE 322. For example, the event 320 may be a traffic event. The MLM 304 may determine, based at least in part on the historical event data, that traffic events within the coverage area 310 correspond to a particular data mix lasting for a particular duration. The MLM 304 may also determine that network traffic is also expected to rise by a particular amount due to current traffic conditions surrounding the coverage area. Thus, the MLM 304 may generate the expected network traffic to predict the data mix and total network load due to the event 320.

In some embodiments, the MLM 304 may model various scenarios using traffic patterns, other events in regions near to the coverage area 310, network data, and other such data. The MLM 304 may then determine a probability score for each scenario. The MLM 304 may then select the scenario with the highest probability score and generate the expected network load based on the scenario.

At step 309, the computing device 302 may determine one or more performance metrics of the 5G network 308 and/or each of the network components 318a-b. The one or more performance metrics may include a current capacity of each of the network components 318a-b, a packet loss rate of the 5G network, an average time of flight for data transmitted through the 5G network, and other such performance metrics.

At step 311, the computing device 302 may access a dynamic threshold. The dynamic threshold may include data indicating one or more data mixes and/or network traffic loads that are likely to cause at least one of the network components 318a-b to fail. For example, the dynamic threshold may indicate that under a certain data mix, the network component 318a is likely to fail. Then, at step 313, the computing device 302 may determine that a new network component 318c is needed to ensure that the 5G network 308 and/or the network components 318a-b do not fail. The computing device 302 may compare the expected network load to the one or more network parameters and/or the dynamic threshold. The computing device 302 may then determine that if the 5G network 308 experiences network traffic (including a data mix) corresponding to the expected network load, that one or more of the network parameters may exceed a limit indicated in the dynamic threshold. Accordingly, the computing device 302 may then determine that one or more of the network components 318a-b are likely to fail under the expected network load.

The computing device 302 may also identify an amount of capacity needed to prevent the one or more network components 318a-b from failing. For example, the computing device 302 may determine that the expected network load would require an SMF (e.g., the network component 318b) to have 15% more capacity in order to prevent the failure of the network component 318b. The computing device 302 may then determine that the new network component 318c should add 20% more capacity to the SMF-functionality of the 5G network 308. Thus, the new network component 318c may be an SMF adding 20% more capacity to the 5G network 308. In other embodiments, the new network component 318c may replicate the network component 318b, and thus double an associated capacity.

At step 315, the computing device 302 may cause the new network component 318c to be generated and deployed within the 5G network 308. Using the system 300 and the process 301, therefore, the 5G network has been adjusted according to the event 320, based on output from the MLM 304.

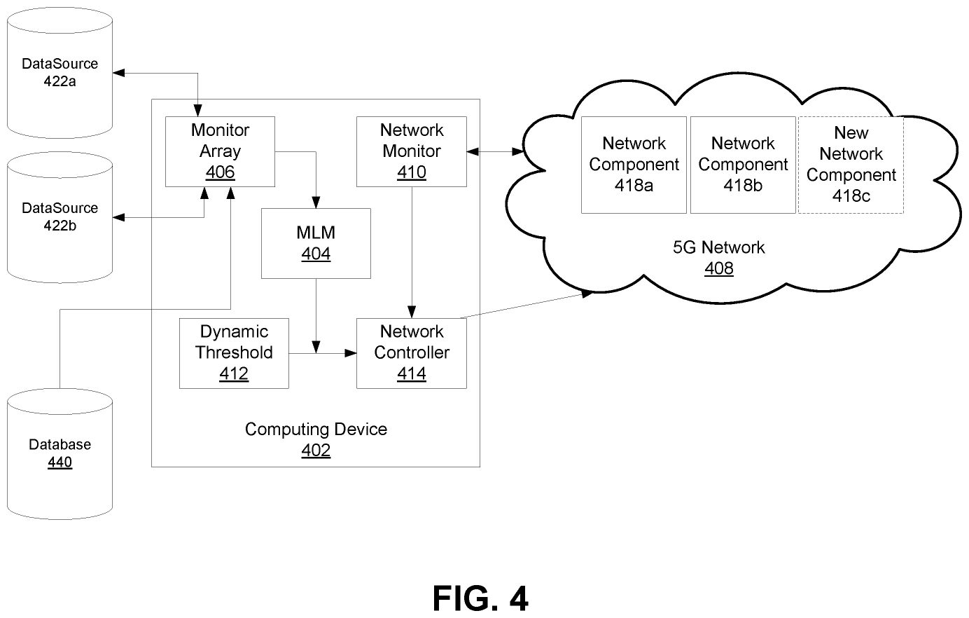

FIG. 4 illustrates a simplified diagram of a system 400 for adjusting a 5G network, according to certain embodiments. The system 400 may be similar to the system 300 and include similar functionalities. The system 400 may include a computing device 402 including an MLM 404, a monitor array 406, a network monitor 410, a dynamic threshold 412, and a network controller 414. The computing device 402 may be configured, in part, to monitor and adjust one or more properties of a 5G network 408. The 5G network 408 may be similar to the 5G network 308 in FIG. 3 and include similar components and functionalities (e.g., network components 418a-b and a new network component 418c).

The computing device 402 may be a single physical or virtual machine, or may be implemented in a distributed, cloud-based architecture. As such, some or all of the components of the computing device 402 may not be implemented on the same device. Similarly, a database 440 may be included in the computing device 402 or may be remote (e.g., accessible via a private cloud network of a 5G wireless provider). The database 440 may include user data associated with only those UEs connected to the 5G network 408 or may include user data associated with UEs associated with a 5G wireless network provider.

The MLM 404 may be similar to the MLM 304, trained to determine an expected network load in response to an event within a coverage area of the 5G network 408. The MLM 404 may be trained on historical event data, historical network data, historical user data, and/or other suitable data. The MLM 404 may include and/or employ an artificial neural network, Bayesian network, ridge regression model, K-nearest neighbors, and/or other machine learning models suitable to predict and generate an expected network load for the 5G network 408.

The monitor array 406 may be configured to automatically access data sources 422a-b for data indicating an event within the coverage area associated with the 5G network 408. In some embodiments, the monitor array 406 may access one or more publicly available websites to determine upcoming events within or around the coverage area. For example, the data source 422a may be a community events calendar hosted by a municipality. The data source 422a may therefore include event data indicating a future event in the coverage area of the 5G network. The monitor array 406 may therefore periodically scan the data source 422a for upcoming events in the coverage area (e.g., a sports game, a parade, a political rally, etc.). In other embodiments, the monitor array 406 may passively access event data. For example, the data source 422b may be a traffic feed, providing traffic data to various recipients. The monitor array 406 may then access a traffic alert associated with the coverage area (e.g., a collision that will impact traffic within the coverage area).

The network monitor 410 may be configured to determine a current state of the 5G network 408 (e.g., a percentage of capacity, a number of UEs connected to the 5G network 408, etc.). The network monitor 410 may also collect and analyze one or more performance metrics associated with the 5G network 408 and or the network components 418a-b. The one or more network parameters may include a current capacity of each of the network components 418a-b, a packet loss rate of the 5G network, an average time of flight for data transmitted through the 5G network, and other such performance metrics. The network monitor 410 may be configured to transmit data indicating the one or more performance metrics to the network controller 414, and/or the MLM 404.

The dynamic threshold 412 may indicate one or more limits associated with network traffic, where exceeding a limit may cause a failure of one or more of the network components 418a-b. Each of the one or more limits may indicate a respective data mix that, when experience by the 5G network 408, is likely to cause one or more of the network components 418a-b to fail. The dynamic threshold 412 may be generated using a machine learning model trained on a 5G network similar to the 5G network 408 and/or other 5G networks.

The network controller 414 may be configured to compare the one or more performance metrics, the expected network load, and/or the dynamic threshold 412 to determine if the 5G network 408 can handle the expected network load. The network controller 414 may also determine a needed capacity for each of the network components 318a-b such that the 5G network 408 can handle the expected network load. The network controller 414 may also be configured to cause the new network component 318c to be generated and deployed within the 5G network 408. The network controller 414 may also cause the new network component 418c to be terminated from the 5G network.

In an embodiment, the monitor array 406 may detect an event within the coverage area associated with the 5G network 408. The monitor array 406 may access event data associated with the event from the data source 422b. The monitor array 406 may also access the database 440 to access user data associated with one or more UEs connected to the 5G network in the coverage area. The monitor array 406 may then transmit the event data and/or the event data to the MLM 404. The MLM 404 may then generate an expected network load associated with the event data and/or the user data. The expected network load may include an expected data mix (or range of data mixes), a duration of the expected network load, and other such information.

The network controller 414 may then access a current state of the 5G network 408, one or more performance metrics of the 5G network (and/or the network components 418a-b), and other such data from the network monitor 410. In some embodiments, the network controller 414 may request information from the network monitor 410. In other embodiments, the network controller 414 may receive periodic or continuous updates from the network monitor 410. The network controller 414 may also access the expected network load and the dynamic threshold 412.

The network controller 414 may then compare one or more of the current state 5G network 408, the one or more performance metrics, the expected network load, and the dynamic threshold to determine if the 5G 408 network can handle the expected network load. In response to determining that the 5G network 408 and/or one or more network components 418a-b may fail under the expected network load, the network controller may cause the new network component 418c to be generated and deployed within the 5G network 408. The new network component 418c may be a replica of an existing network component (e.g., the network components 418a-b), or may be a different network component. The new network component 418c may be configured to provide a minimal capacity needed to the 5G network 408 (e.g., 10% additional capacity to the 5G network 408).

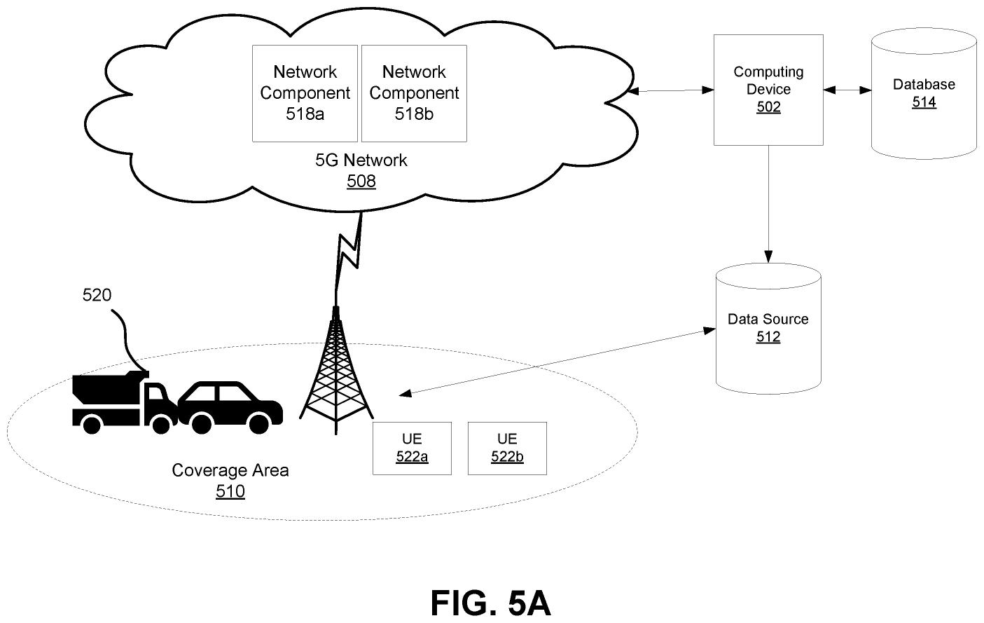

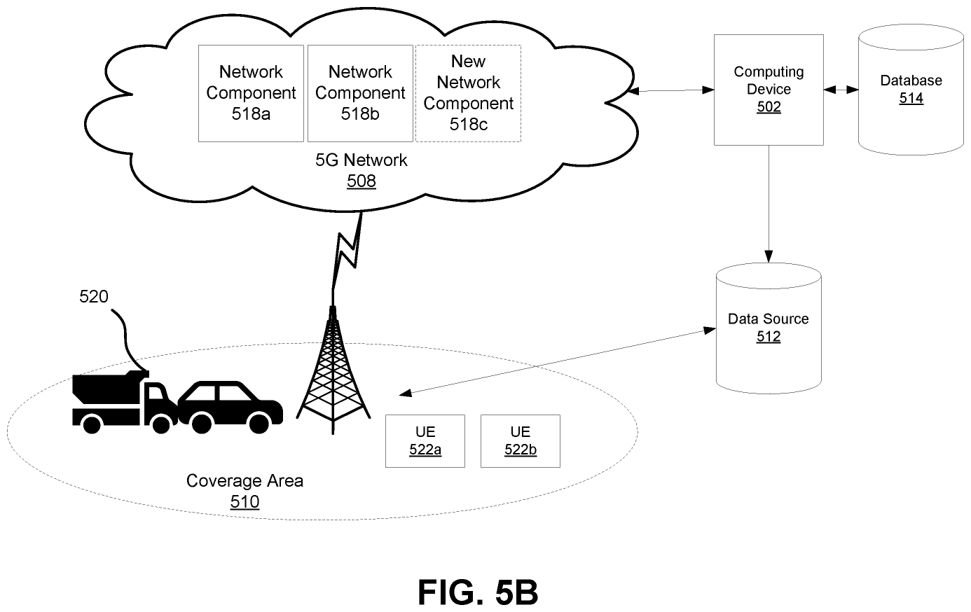

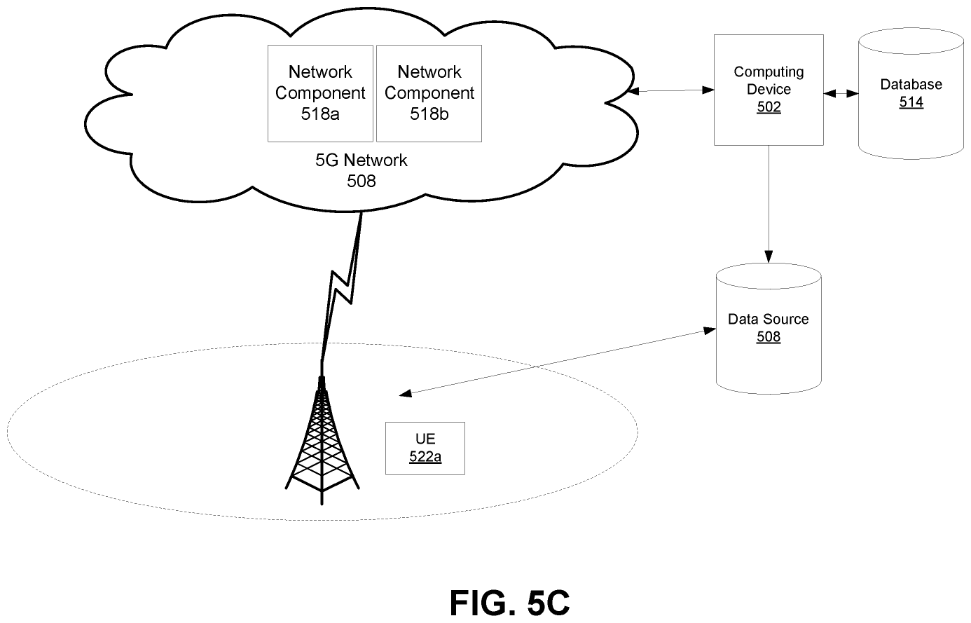

FIG. 5A illustrates a 5G network 508 with an event 520 in a coverage area, according to some embodiments. The 5G network 508 may include network components 518a-b. The 5G network 508 may be similar to the 5G network 308 in FIG. 3 and include similar components and functionalities. Thus, the 5G network 508 may be similar to the system 100 described in FIGS. 1A-B. A computing device 502 may be similar to the computing device 402 in FIG. 4 and include similar components and functionalities. Specifically, the computing device 502 may be configured to monitor and adjust the 5G network 508, as well as access a data source 512 and a database 514. The computing device 502 may also perform some or all of the functions described herein using an MLM such as the MLM 404. The data source 512 may collected event data associated with events that happen in and around a coverage area 510 of the 5G network 508. The database 514 may include user data associated with one or more UE's (e.g., UEs 522a-b) within the coverage area 510.

An event 520 may occur within the coverage area 510 of the 5G network 508. As illustrated, the event 520 may be a vehicular accident, although the event may be any type of scheduled or unscheduled event. UEs 522a-b may be within the coverage area 510 and connected to the 5G network 508. The data source 512 may be a traffic data source, monitoring roadways in and/or around the coverage area 510. The data source 512 may then determine the occurrence of the event 520 and create event data associated with the event 520. The computing device 502 may access the event data from the data source 512, either passively (e.g., receiving the event data via an RSS feed or other such feed), or actively (e.g., querying a website or other data source).

The computing device 502 may also access user data associated with the UEs 522a-b from the database 514. The user data may include data usage statistics associated with each of the UEs 522a-b, such as an average data mix, an average data usage, and other such statistics. For example, the UE 522a may tend to use a higher amount of voice data than average, while using less application data. The UE 522b may tend to use higher amounts of application data and multimedia messaging service (MMS) data, while using less voice data. Although only two UE 522a-b are shown, it should be understood that any number of UEs may be connected to the 5G network 508 within the coverage area 510.

The computing device 502 may provide the event data, the user data, and or other data to the MLM. The MLM may then generate an expected network load. The expected network load may include an expected data mix, total network load, an expected duration of the expected network load, and other information associated with the 5G network 508. For example, the expected network load may indicate a high level of voice data in a data mix due to higher-than-usual call volumes during traffic events similar to the event 520. The expected network load may also be based in part on the particular user data associated with each of the UEs 522a-b in the coverage area 510.

FIG. 5B illustrates the computing device 502 adjusting the 5G network 508 in response to the event 520, according to certain embodiments. Continuing the example from FIG. 5A, the computing device 502 may then compare the expected network load to one or more performance metrics of the 5G network 508, a current state of the 5G network (including the network components 518a-b, capacities thereof, and other such information), and a dynamic threshold. The dynamic threshold may include limits associated with the network components 518a-b correlated to specific data mixes and/or network traffic levels. The limits may indicate that one or more of the network components 518a-b are likely to fail if the limit(s) are exceeded.

The computing device 502 may then determine that the expected network load associated with the event 520 and the UEs 522a-b, combined with the current state of the 5G network, exceeds the limits of dynamic threshold and a new network component 518c may be required to prevent a failure. For example, if the network component 518a is an IMS, the computing device 502 may determine that the increase in voice data indicated in the expected network load may cause the network component 518a to fail. The computing device 502 may determine that the expected network load would require a 10% increase in services provided by the network component 518a. Thus, the computing device 502 may cause the new network component 518c to be generated and deployed within the 5G network 508, where the new network component 518c is an IMS configured to provide a 15% increase in the services provided by the network component 518a.

In another example, the network component 518b may be a UPF. The expected network load may indicate an increase in application data due to the UEs connected to the 5G network 508 within the coverage area 510 (e.g., the UE 522b). The computing device 502 may therefore determine that the network component 518b may fail under the expected network load to the increase in application data. The computing device 502 may then cause the new network component 518c to be generated and deployed within the 5G network 508. The new network component 518c may be a replica of the network component 518b and provide UPF services to the 5G network 508 (or the UEs connected thereto). The new network component 518c may therefore double the capacity of the UPF services of the 5G network 508.

In either case, the new network component 518c may prevent some or all of the network components 518a-b from failing under the traffic load experienced by the 5G network 508 due to the event 520. Furthermore, although only one new network component 518c is shown in FIG. 5B, it should be understood that any number of new network components may be generated and deployed based on the event 520 and or the UEs 522a-b, replicating some or all of the components described in FIGS. 1A-B.

FIG. 5C illustrates the computing device 502 adjusting the 5G network 508 due to the termination of an event, according to certain embodiments. The event 520 in FIGS. 5A and 5B may terminate at some point. For example, the vehicular accident may be cleared, alleviating related traffic problems. Furthermore, UE 522b may no longer be connected to the 5G network 508 in the coverage area 510. In some embodiments, the computing device 502 may access data corresponding to the termination of the event 520 from the data source 512. Additionally or alternatively, the computing device 502 may determine that the network traffic and the data mix has reduced to normal levels and thus that the event 520 has terminated (e.g., via a network monitor such as the network monitor 410 in FIG. 4). The computing device 502 may also determine that there are less UEs connected to the 5G network 508 in the coverage area 510. The computing device 502 may therefore cause the new network component 518c to be de-instantiated and removed from the 5G network 508. In some embodiments, the computing device 502 may utilize the MLM to determine a new expected network load and adjust the network components 518a-b accordingly.

Throughout the example illustrated in FIGS. 5A-C, the computing device 502 may collect data associated with the 5G network 508, the user data associated with the UEs 522a-b, and/or the event 520. For example, the computing device 502 may collect performance metrics of the 5G network during the event 520 such as packet loss, response time, and other network performance metrics. The computing device 502 may also collect network statistics of the 5G network 508 during the event 520 such as total network traffic, an experienced data mix, a duration of a traffic increase (and/or shift in data mix) due to the event 520, and other such statistics. The computing device 502 may compare the collected data to the expected network load generated by the MLM. An accuracy rating or other metric may be assigned to the expected network load and provided to the MLM via a reward function to tune and/or retrain the MLM. Thus, during a subsequent event, the MLM may generate a more accurate expected network load.

The computing device 502 may provide the collected data to a training dataset. The training dataset may be stored locally on the computing device 502 or in a central database of the 5G wireless network provider. The training dataset, including the collected data, may then be used by other computing devices to train other MLMs, such that the other MLMs may also generate more accurate expected network loads.

Although the example illustrated in FIGS. 5A-C describe the event 520 as a vehicular accident, it should be understood that similar processes may be performed for other types of events. For example, the event 520 may be a parade. In that case, the computing device 502 may generate the new network component 518c prior to the event in order to prevent the failure of network components 518a-b. The computing device 502 may also monitor the performance of the 5G network 508 during the event and adjust the network components thereof during the event (e.g., based on user data, some other event, etc.). Thus, the systems and processes described in relation to FIGS. 5A-C may be used to predict an expected network load for any event, scheduled or unscheduled, and adjust the 5G network 508 accordingly.

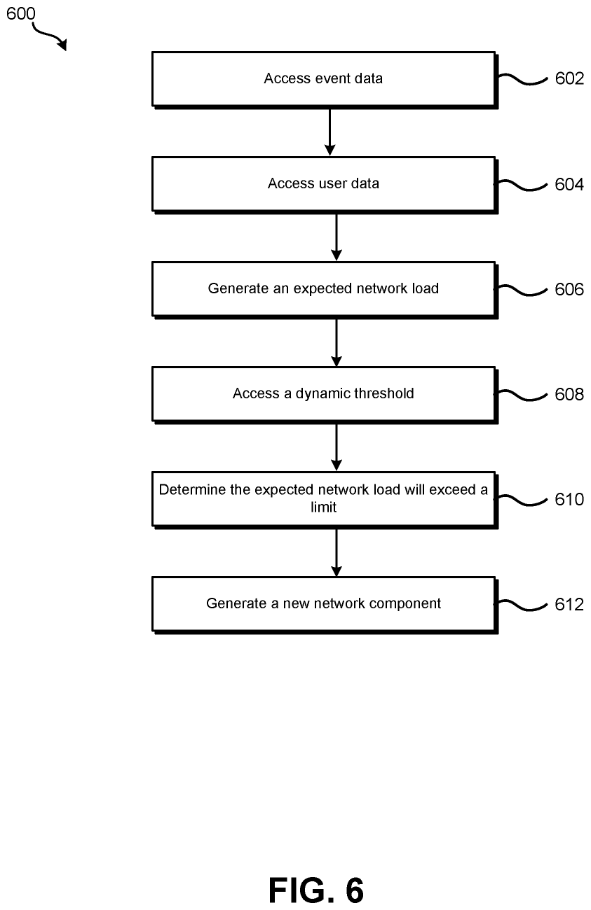

FIG. 6 illustrates a flowchart of a method 600 for adjusting a 5G network, according to certain embodiments. The method 600 may be performed by some or all of the systems described herein such as the systems 300 and 400 in FIGS. 3 and 4, respectively, and the computing device 502 in FIGS. 5A-C. Some or all of the steps of the method 600 may be combined and/or performed in a different order than shown. Furthermore, some of the steps of the method 600 may be skipped altogether.

At step 602, the method 600 may include accessing, by a computing device, event data from a data source. The event data may correspond to an event affecting a region covered by a 5G network comprising a plurality of network components. The computing device may be similar to the computing device 402 in FIG. 4, and include components such as an MLM, a network monitor, a monitor array, a network controller, and other components. The data source may be a news source, RSS feed, a public website, an events calendar, emergency services communications feed, or other such data source. The computing device may access the event data passively, receiving the event data (e.g., via an RSS feed), or may actively access the event data by requesting information and/or scanning the data source for the event data (e.g., an events calendar on a website). The event may be a scheduled event such as parade, concert, rally, etc., or may be an unscheduled event such as a traffic jam, weather event, or other such event. The event may occur within the region or may occur outside the region.

The region may be a coverage area associated with the 5G network, such as the coverage area 510. Thus, the 5G network may provide wireless service to one or more UEs within the region. The plurality of network components may include any or all of the systems and components described in FIGS. 1A, 1B, and 2. Some or all of the plurality of network components may be implemented in a cloud-based architecture, hosted by a public cloud-services provider. The 5G network may be a standalone 5G network.

At step 604, the method 600 may include accessing, by the computing device, user data corresponding to a UE within the region. The user data may include historical data usage information associated with the UE. The user data may include a voice data usage, an application data usage, a short-message service data usage, location information, and time information. The user data may include an average data mix, an average data usage, time-based information, location data, and other such information. The user data may be stored on a database. The database may include user data of UEs connected to the 5G network and/or the database may be a central database that includes user data of one or more UEs associated with a 5G wireless network provider.

At step 606, the method 600 may include generating, by the computing device, an expected network load. The computing device may use an MLM to generate the expected network load. The MLM may use at least one of the event data and the user data to generate the expected network load. The MLM may include and/or employ an artificial neural network, Bayesian network, ridge regression model, K-nearest neighbors, and/or other machine learning models suitable to predict and generate the expected network load for the 5G network. The MLM may be trained, at least in part, using historical user data, historical event data, and/or historical network data (together, “training data”). The training data may be stored on the computing device, and therefore be unique to the 5G network. Additionally or alternatively, the training data may be stored in a central database, accessible by other computing devices and/or MLMs.

The expected network load may include an expected data mix, total network load, an expected duration of the expected network load, and other information associated with the 5G network. Because the MLM may be trained on the training data and provided with the event data and user data, the MLM may therefore predict the expected network load during the event.

At step 608, the method 600 may include accessing, by the computing device, a dynamic threshold associated with the 5G network. The dynamic threshold may include one or more limits associated with the plurality of network components, correlated to specific data mixes (including variable amounts of a plurality of data types) and/or total network loads. The limits may indicate that one or more of the plurality of network components may fail if a limit is exceeded. The dynamic threshold may be generated for the 5G network via the injection of synthetic data into a test 5G network. In other embodiments, the dynamic threshold may be generated for a generic 5G network.

At step 610, the method 600 may include determining, by the computing device, that the expected network load will cause the 5G network to exceed at least one limit of the one or more limits of the dynamic threshold. The computing device may compare the expected network load to one or more performance metrics of the 5G network and a current state of the 5G network. The computing device may then identify a specific network component likely to fail based on the expected network load.

At step 612, in response to determining that the expected network load will exceed the at least one limit of the one or more limits, the method 600 may include generating, by the computing device, a new network component to be deployed in the 5G network. The computing device may generate the new network component itself or may cause the new network component to be generated by some other computing device (e.g., a cloud computing instance hosted by a public cloud-services provider). The new network component may be configured to add a minimum amount of network capacity to the 5G network covering the region such that the network capacity meets or exceeds the expected network load. For example, the computing device may cause a new UPF to be generated and deployed within the 5G network such that only a 10% increase in UPF-functionality is added to the 5G network. In some embodiments, room for error may be provided (e.g., adding a 12% increase in UPF functionality).

In some embodiments, the method 600 may include determining, by the computing device, that a network load is below the at least one limit of the one or more limits of the dynamic threshold. The computing device may determine the network load via a network monitor such as the network monitor 410 in FIG. 4. The network load may have fallen below the expected network load due to the event terminating, as is described in FIGS. 5A-5C. The computing device may then cause the new network component to be terminated and removed from the 5G network.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method, comprising:
accessing, by a computing device, event data from a data source, the event data corresponding to an event affecting a region covered by a 5G network comprising a plurality of network components;
accessing, by the computing device, user data corresponding to a user equipment within the region covered by the 5G network;
generating, by the computing device and using a machine learning model, an expected network load, wherein the machine learning model uses at least one of the event data and the user data to generate the expected network load;
accessing, by a computing device, a dynamic threshold associated with the 5G network, the dynamic threshold comprising one or more limits associated with the plurality of network components;
determining, by the computing device, that the expected network load will cause the 5G network to exceed at least one limit of the one or more limits of the dynamic threshold; and
in response to determining that the expected network load will exceed the at least one limit of the one or more limits:
generating, by the computing device, a new network component in the 5G network based at least in part on the expected network load.

2. The method of claim 1, further comprising:
determining, by the computing device, that a network load is below the at least one limit of the one or more limits of the dynamic threshold; and
causing, by the computing device, the new network component to be removed from the 5G network.

3. The method of claim 1, wherein the new network component is configured to add a minimum amount of a network capacity to the 5G network covering the region such that the network capacity meets or exceeds the expected network load.

4. The method of claim 1, wherein the one or more limits are based at least in part on a data mix, the data mix comprising variable amounts of a plurality of data types.

5. The method of claim 1, wherein the user data comprises historical data usage information associated with the user equipment, the historical data usage information further comprising at least one of a voice data usage, an application data usage, a short-message service data usage, location information, and time information associated with the historical data information.

6. The method of claim 1, wherein the user data comprises at least one of an events database, a news source, an emergency communications network, and traffic data.

7. The method of claim 1, wherein the 5G network is implemented in a distributed cloud-based architecture.

8. The method of claim 1, wherein the 5G network comprises a standalone 5G network.

9. The method of claim 1, wherein the dynamic threshold is generated at least in part by injecting synthetic data into a test 5G network.

10. A system, comprising:
one or more processors;
a monitor array;
a machine learning model;
a network controller; and
a non-transitory computer-readable medium, comprising instructions that, when executed by the one or more processors, cause the system to perform operations to:
access, by the monitor array, event data from a data source, the event data corresponding to an event affecting a region covered by a 5G network comprising a plurality of network components;
access, by the monitor array, user data corresponding to a user equipment within the region covered by the 5G network;
generate, by the machine learning model, an expected network load, wherein the machine learning model uses at least one of the event data and the user data to generate the expected network load;
access, by the network controller, a dynamic threshold associated with the 5G network, the dynamic threshold comprising one or more limits associated with the plurality of network components;
determine, by the network controller, that the expected network load will cause the 5G network to exceed at least one limit of the one or more limits of the dynamic threshold; and
in response to determining that the expected network load will exceed the at least one limit of the one or more limits:
generate, by the network controller, a new network component in the 5G network based at least in part on the expected network load.

11. The system of claim 10, wherein a network monitor collects data associated with a current state of the 5G network and/or one or more performance metrics of the 5G network.

12. The system of claim 11, wherein the network controller utilizes the collected data associated with the current state of the 5G network and/or the one or more performance metrics to determine that the expected network load will cause the 5G network to exceed at least one limit of the one or more limits of the dynamic threshold.

13. The system of claim 10, wherein the machine learning model includes one or more of an artificial neural network, a Bayesian network, a ridge regression model, and a K-nearest neighbors model.

14. The system of claim 10, wherein the user data comprises at least one of an events database, a news source, an emergency communications network, and traffic data.

15. The system of claim 10, wherein the 5G network is implemented in a distributed cloud-based architecture.

16. The system of claim 10, wherein the 5G network comprises a standalone 5G network.

17. The system of claim 10, wherein the dynamic threshold is generated at least in part by injecting synthetic data into a test 5G network.

18. A non-transitory computer-readable medium comprising instructions that, when executed by a processor, cause the processor to perform operations comprising:
accessing, by a computing device, event data from a data source, the event data corresponding to an event affecting a region covered by a 5G network comprising a plurality of network components;
accessing, by the computing device, user data corresponding to a user equipment within the region covered by the 5G network;
generating, by the computing device and using a machine learning model, an expected network load, wherein the machine learning model uses at least one of the event data and the user data to generate the expected network load;
accessing, by a computing device, a dynamic threshold associated with the 5G network, the dynamic threshold comprising one or more limits associated with the plurality of network components;
determining, by the computing device, that the expected network load will cause the 5G network to exceed at least one limit of the one or more limits of the dynamic threshold; and
in response to determining that the expected network load will exceed the at least one limit of the one or more limits:
generating, by the computing device, a new network component in the 5G network based at least in part on the expected network load.

19. The non-transitory computer-readable medium of claim 18, the operations further comprising:
determining, by the computing device, that a network load is below the at least one limit of the one or more limits of the dynamic threshold; and
causing, by the computing device, the new network component to be removed from the 5G network.

20. The non-transitory computer-readable medium of claim 18, wherein the new network component is configured to add a minimum amount of a network capacity to the 5G network covering the region such that the network capacity meets or exceeds the expected network load.
